(19) United States
(12) Patent Application Publication
(10) Pub. No.: US 2026/0112099 A1
(43) Pub. Date: Apr. 23, 2026

(54) SYSTEM AND METHOD FOR GENERATING A REAL-TIME, INTERACTIVE COMPANION ON A USER DEVICE

(71) Applicant: Animation Inc., DOVER, DE (US)

(72) Inventors: Evgeny Zatepyakin, Vienna (AT); Siarhei Hanchar, Limassol (CY)

(21) Appl. No.: 19/377,084

(22) Filed: Nov. 3, 2025

(51) Int. Cl. G06T 13/40; G06F 40/30; G06N 3/044; G06N 3/0985

(52) U.S. Cl. CPC G06T 13/40; G06F 40/30; G06N 3/044; G06N 3/0985

(57) ABSTRACT

The present invention relates to a system and method for generating a real-time, interactive companion on a user device. The system comprises one or more processors and a memory. The memory stores executable instructions that, when executed by the one or more processors, cause the system to receive at least one user input comprising at least one of text, voice, touch, or gesture data. The processor extracts semantic and emotional context from the user input using a natural-language processing module configured to generate embeddings representing at least one of linguistic content, conversational intent, or affective cues and processes the embeddings, via a motion mapping and emotional mapping module to generate animation parameters defining at least one of facial expressions, gestures, and full-body motion. Based on the animation parameter, a rendering engine renders an emotionally guided digital companion in temporal synchronization with the received user input. The motion synthesis and rendering inferences are performed on the user device without transmitting raw sensor inputs or generated animation parameters off-device. This on-device execution ensures low-latency, enhanced privacy, and reduced reliance on cloud infrastructure.

### FIELD OF THE INVENTION

The present invention relates to the field of real-time generation of animated characters and, more particularly, to a system and method for generating a real-time, interactive companion on a user device. This enables real-time, low-latency animation, enhanced privacy through on-device processing, and reduced reliance on cloud infrastructure.

### BACKGROUND

### Interpretation Considerations

This section describes the technical field in detail and discusses problems encountered in the technical field. Therefore, statements in the section are not to be construed as prior art.

### Discussion

Nowadays, animation systems have gained rapid popularity in recent years. The animation systems are software tools or frameworks designed to create the illusion of movement by displaying a series of images or frames in a sequence. Existing animation systems incorporate techniques such as scripting, procedural animation, and representational animation, and often include components like animation clips and controllers to smoothly blend and transition between different motions. These systems are fundamental in fields such as film, video games, virtual reality, and computer graphics, allowing the creation of complex animated sequences that bring static images or models to life

Traditional animation systems rely on fixed templates or pre-recorded sequences, resulting in consistently clear output with few mistakes or glitches. This makes the animation look smooth and makes user's engagement more. These animation systems help users learn essential skills like timing and how things move. The repetitive and predictable outputs lack variation and fail to adapt to user input, reducing the naturalness and engagement of the interaction. While this approach simplifies production, it inherently yields repetitive, predictable animations that lack diversity and spontaneity. The dependency on such templates limits the creativity and makes the animation less dynamic.

The traditional systems use static animation frames, which offer the advantage of predictability and ensure consistent output without unexpected errors. This consistency makes the animation smooth and enjoyable for viewers. The static animation frames limit the system's ability to generate novel or contextually appropriate responses, making an animated character appear robotic and diminishing emotional connection with the user. These static animation frames limit the perception of natural human-like emotional changes, which rely on continuous motion and nuanced expression, thereby negatively impacting the overall user experience.

Existing generative animation systems also depend on cloud-based computation for processing-intensive artificial intelligence (AI) models, which introduces significant latency due to round-trip data transmission between the device and remote servers. The round-trip transmission time, combined with the high computational demands of large AI models hosted in the cloud, causes delays in generating animations. This latency affects the system's responsiveness and real-time interaction quality, causing the animated characters to respond more slowly and diminishing the overall user experience.

The existing animation systems rely on the cloud, requiring a constant internet connection. As a result, they cannot function well in areas with slow or no internet, limiting where and how the system can be used. This dependency makes the system inoperable in low-bandwidth or offline environments, significantly limiting its usability in many real-world scenarios such as remote locations, unstable networks, or situations where privacy concerns restrict cloud access. As a result, the users experience interruptions or complete service loss when connectivity is poor or unavailable, which hampers the consistent delivery of smooth, contextually appropriate animation responses.

Further, the traditional and even specific modern systems continue to face significant limitations, which means transmitting sensitive user data, such as voice, behaviour, and contextual information, to third-party servers raises serious privacy and data security concerns. This data transmission exposes users to risks of unauthorized access, data breaches, or unintended sharing of personal and proprietary information.

Cloud infrastructure used in traditional generative animation systems incurs high operational costs, including server maintenance, network management, and scalability to handle varying workloads. These costs can be excessive for individual developers, startups, or small studios.

Therefore, there is a need for a system and method that seamlessly integrates audio and contextual input, facilitates the widespread deployment of avatars in consumer applications, enables integrated support for multi-modal animation, and provides low latency, thereby significantly enhancing operational intelligence, privacy preservation, and overall animation performance.

### SUMMARY

An objective of the present invention is to provide a system and method that enable the dynamic, continuous generation of real-time animation derived from audio or contextual input, thereby improving engagement.

Another objective of the present invention is to provide a system and method that ensures on-device computation. This reduces costs by eliminating the need for cloud infrastructure and lowering system complexity, as there is no dependency on network connectivity.

Yet another objective of the present invention is to provide a system and method that enables offline-ready animation without requiring continuous internet connectivity, thereby improving cost-effectiveness.

Still another objective of the present invention is to provide a system and method that enables synchronized body, face, and lip-sync animation driven by conversation context. This synchronization enhances user engagement and retention by creating more natural and emotionally expressive interactions between the animated character and the user.

This and other objectives are achieved by a system and method for generating a real-time, interactive companion on a user device, as defined in the features of the independent claims. Additional advantageous embodiments and improvements of the invention are listed in the dependent claims. The use of expressions like “ . . . aspect according to the invention” or “in one embodiment” or similar terminology is intended to refer to examples or embodiments consistent with the broadest scope of the invention as defined by the independent claims.

According to a first aspect of the invention, the present invention discloses a generative animation system. The system comprises one or more processors and a memory. The memory stores executable instructions that, when executed by the one or more processors, cause the system to: (a) receive at least one user input comprising at least one of text, voice, touch, or gesture data; (b) extract semantic and emotional context from the user input using a natural-language processing module configured to generate embeddings representing at least one of linguistic content, conversational intent, or affective cues; (c) process the embeddings, via a motion mapping and emotional mapping module to generate animation parameters defining at least one of facial expressions, gestures, and full-body motion responsive to the extracted semantic and emotional context; and (d) render, using a rendering engine, an emotionally-guided digital companion in temporal synchronization with the received user input based on the animation parameters. The motion-synthesis and rendering inferences are performed on the user device without transmitting raw sensor inputs or generated animation parameters off-device. This enables the dynamic, accurate, and adaptive generation of animation characters, enhancing user engagement.

In an embodiment of the present invention, the natural-language processing module comprises a transformer-based encoder-decoder network configured to generate latent conversational embeddings that encode both semantic intent and emotional tone, thereby improving natural-sounding, emotionally aware interactions.

In another embodiment of the present invention, the mapping module comprises a diffusion, variational autoencoder, or hybrid transformer architecture trained to generate temporally coherent motion sequences conditioned on conversational embeddings, enabling synchronized body, face, and lip-sync animation driven by conversation context. This synchronization enhances user engagement.

In another embodiment of the present invention, the mapping module comprises an emotional-mapping subnetwork configured to correlate sentiment or emotion scores from the natural-language processing module with motion vectors defining posture, gaze, and gesture magnitude. This allows multimodal expression that better reflects the intended sentiment.

In another embodiment of the present invention, the one or more processors normalize multimodal sensor inputs, including device orientation, accelerometer data, and ambient audio, to a unified temporal reference prior to encoding, ensuring reliable and synchronized multimodal input processing.

In yet another embodiment of the present invention, the system further comprises a short-term affective-state memory configured to store recent emotional-state vectors for use in producing temporally consistent expressive behavior. This prevents abrupt or unnatural emotional shifts.

In yet another embodiment of the present invention, the mapping module further includes a temporal modeling component employing attention or recurrent layers to predict pose transitions and maintain movement continuity, resulting in smooth, continuous movement in generated animations.

In yet another embodiment of the present invention, the on-device optimization includes hardware-aware compilation or training-stage quantization of pre-quantized weights or activations to minimize latency and power consumption during inference, enabling efficient on-device operation.

Still another embodiment of the present invention includes a rendering engine with a motion-retargeting module configured to map generated animation parameters to a locally stored skeletal rig or mesh of a user-customized character. This supports personalized character rendering across devices.

Still another embodiment of the present invention, the rendering engine composites the animated companion within a conversational, gaming, or augmented-reality interface rendered by the user device, enhancing the interactive and immersive user experience.

Still another embodiment of the present invention, the system receives text or audio tokens from a remote server and, upon user consent, transmits non-identifying usage metadata.

According to a second aspect of the present invention, the present invention discloses a computer-implemented method for generating a real-time, interactive companion on a user device. The method comprising: (a) receiving a user input comprising at least one of text, voice, touch, or gesture data; (b) extracting semantic and emotional context from the user input using a natural-language processing module that generates embeddings representing linguistic content, conversational intent, or affective cues; (c) generating, by a mapping module executed locally on the user device, animation parameters defining expressions, gestures, and full-body motion responsive to the extracted context; (d) performing a pre-deployment optimization of a generative motion-synthesis network for on-device inference using one or more model-reduction or acceleration techniques selected from pruning, quantization, weight sharing, low-rank approximation, or knowledge distillation; and (e) rendering, by the user device, a three-dimensional animated companion in temporal synchronization with the received inputs based on the generated animation parameters, The motion-synthesis and rendering inferences are performed on the user device without transmitting raw sensor inputs or generated animation parameters off-device. This method enables dynamic, continuous generation of real-time animations from audio or contextual inputs, improving both accuracy and user engagement while preserving privacy through on-device computation.

In an embodiment of the present invention, extracting semantic and emotional context comprises generating transformer-based embeddings encoding sentiment, intent, and conversational state, leading to more nuanced and context-aware responses.

In another embodiment of the present invention, generating the animation parameters comprises predicting sequential joint rotations, facial blendshapes, and body poses using a diffusion or variational-autoencoder-based network conditioned on the embeddings, generating lifelike animation sequences.

In another embodiment of the present invention, the method further comprises mapping emotion embeddings to animation-control parameters through an emotional-mapping subnetwork that aligns expressive behavior with conversational tone, creating more emotionally coherent characters.

In yet another embodiment of the present invention, the method further comprises maintaining an affective-state memory buffer storing recent emotional-state vectors for use by the generative motion-synthesis network to ensure temporal coherence of emotional responses and to avoid abrupt emotional changes in the generated animated companion.

In yet another embodiment of the present invention, the mapping module includes modality-specific encoder layers for linguistic, acoustic, and gesture inputs and a shared decoder configured to synthesize motion trajectories, enabling precise multimodal representation and improved processing flexibility.

In yet another embodiment of the present invention, the method further comprises generating the motion and/or emotion mapping by distilling parameters from a larger reference model to create a compact model executable within computational limits of the user device, enabling efficient execution within the computational constraints of the user device.

In still another embodiment of the present invention, the method further comprises executing inference using pre-quantized weights or activations produced during training-time, post-training quantization, or quantization-aware training to reduce model size and memory transfers without performing dynamic quantization of intermediate activations at runtime, making real-time operation on a local device feasible.

In still another embodiment of the present invention, the rendering comprises retargeting the generated animation parameters onto a three-dimensional character rig stored locally and compositing the resulting animation within a communication, gaming, or extended-reality interface, allowing smooth integration in communication, gaming, or extended-reality scenarios.

In still another embodiment of the present invention, the method further comprises receiving text or audio tokens from a remote server and, upon user consent, transmitting non-identifying usage metadata.

According to a third aspect of the present invention, the present invention discloses a computer-implemented method for compacting and deploying an interactive companion. The method comprises: (a) receiving training data comprising audio, textual, and motion data annotated with emotional context; (b) compacting a generative model using at least one reduction technique selected from pruning, quantization, weight sharing, or knowledge distillation to form an optimized on-device motion-synthesis network; (c) executing the compact network locally on a user device to transform user inputs into animation parameters defining expressive motion and gesture of a three-dimensional character; and (d) integrating the compact network and generated animation parameters into a host platform comprising at least one of a conversational interface, virtual-assistant framework, gaming engine, or augmented-reality environment. This method enables synchronized body, face, and lip-sync animation driven by the context of the user input. This synchronization enhances user engagement and retention by creating more natural and emotionally expressive interactions between the animated character and the user.

The system and method described in the present invention enable the dynamic and continuous generation of real-time animations from audio or contextual inputs, enhancing both accuracy and user engagement while preserving privacy through on-device computation. By eliminating the need for cloud infrastructure, the system reduces costs and system complexity, avoiding dependence on network connectivity. This offline-ready capability enables seamless animation generation even in environments with limited or no internet access, making the system more cost-effective and versatile than conventional animation methods. Furthermore, the system provides synchronized body, face, and lip-sync animation driven by conversation context, resulting in more natural and emotionally expressive interactions that enhance user engagement and retention. Therefore, the present invention is highly efficient, flexible, and well-suited for interactive applications across various domains.

### BRIEF DESCRIPTION OF THE DRAWINGS

Various aspects, as well as embodiments of the present invention, are better understood by referring to the following detailed description. To better understand the invention, the detailed description should be read in conjunction with the drawings. However, the drawings depict only some embodiments of the invention and should not be taken as limiting its scope.

FIG. 1(A) illustrates a system for generating an emotionally reactive animated companion on a user device in accordance with an exemplary embodiment of the present invention;

FIG. 1(B) illustrates a system for generating an emotionally reactive animated companion on a user device in accordance with another exemplary embodiment of the present invention;

FIG. 2 illustrates a detailed architecture of the motion mapping and emotional mapping module in accordance with an exemplary embodiment of the present invention;

FIG. 3 illustrates a process of model-compaction and deployment in accordance with an exemplary embodiment of the present invention;

FIG. 4 is a flowchart depicting a method for generating an emotionally-guided digital companion on a user device in accordance with an embodiment of the present invention;

FIG. 5 illustrates a visual example of an affective mapping process performed by an emotional-mapping subnetwork, correlating emotion embeddings to motion-control parameters in accordance with an embodiment of the present invention;

FIG. 6 illustrates a rendering pipeline of a rendering engine that applies generated animation parameters to a 3D character rig and composites the animated companion for real-time display in accordance with an embodiment of the present invention;

FIG. 7 illustrates exemplary hardware environments for on-device deployment of the compact generative animation system in accordance with an embodiment of the present invention;

FIG. 8 illustrates user-interface mock-ups demonstrating real-time animated companion behavior within specific host platforms in accordance with an embodiment of the present invention;

FIG. 9 illustrates an analytical comparison highlighting the performance advantages of the disclosed on-device compact generative animation system against conventional cloud-based inference in accordance with an embodiment of the present invention; and

FIG. 10 illustrates a feedback loop maintaining affective continuity by updating the emotion-state memory based on ongoing user interactions inference in accordance with an embodiment of the present invention

### DETAILED DESCRIPTION

In the following description, for the purpose of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments, but not others.

The present invention discloses a system and method for generating an emotionally reactive animated companion on a user device that enables dynamic and continuous generation of real-time animation from audio or contextual inputs, enhancing accuracy and user engagement. Additionally, on-device computation and the absence of network connectivity dependency improve cost-effectiveness and preserve privacy.

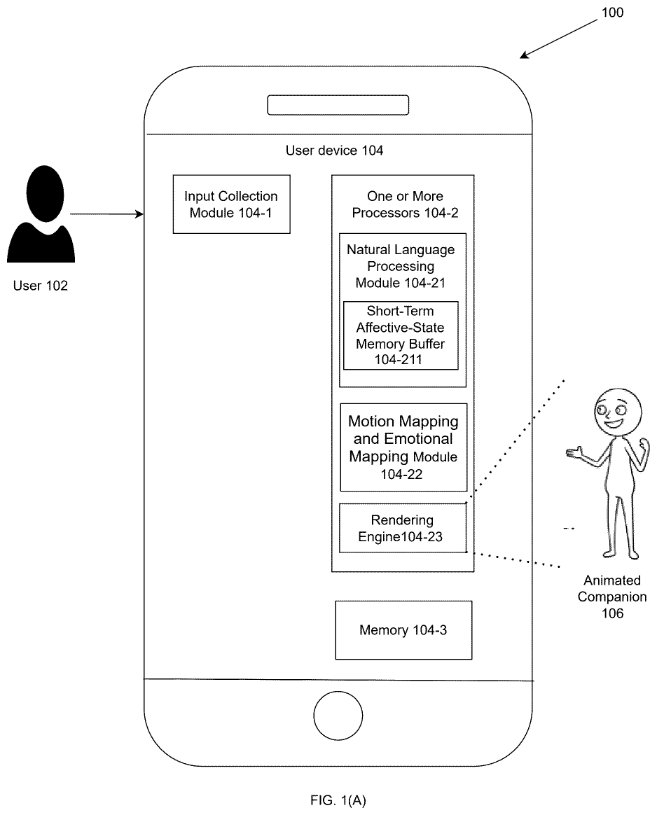

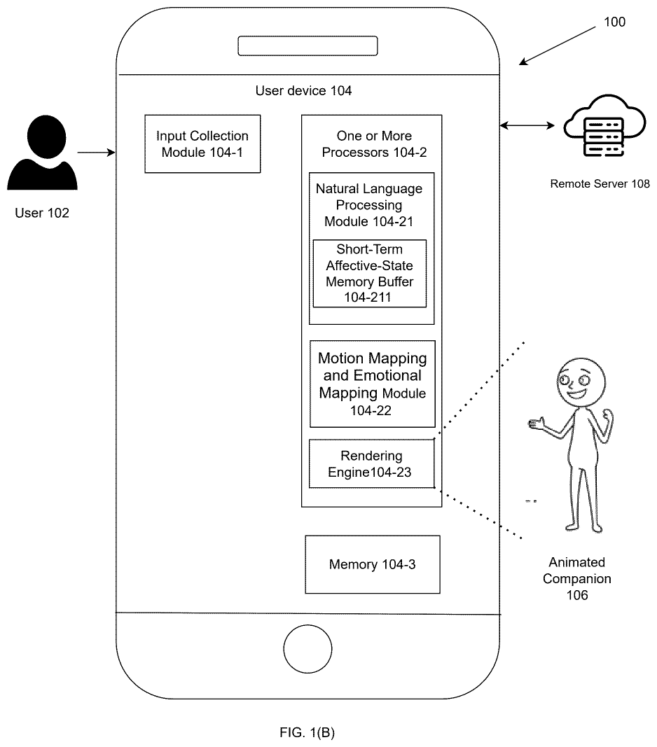

Specific embodiments of the invention will now be described in detail with reference to the accompanying FIG. 1(A)-10. In the following detailed description of embodiments of the invention, numerous specific details are set forth in order to provide a more thorough understanding of the invention. In other instances, well-known features have not been described in detail to avoid obscuring the invention.

FIG. 1(A) illustrates a system 100 for generating an emotionally reactive animated companion 106 on a user device 104 in accordance with an exemplary embodiment of the present invention. The system 100 comprises a user 102 and a user device 104. The user 102 interacts with the user device 104 to generate the animated companion 106. The user device 104 includes, but is not limited to, smartphones, tablets, AR glasses, extended reality headsets, or laptops. The user device 104 comprises an input collection module 104-1, one or more processors 104-2, and a memory 104-3 that hosts one or more key computational modules for emotion recognition, animation synthesis, and interactive rendering. The memory 104-3 stores one or more executable instructions or algorithms, executed by the one or more processors 104-2 to carry out the overall operation of the system 100. This causes the system 100 to perform its various functions entirely locally on the user device 104, ensuring quick response times and user 102 privacy.

The input collection module 104-1 actively receives at least one user input. The received user input is rich and varied, comprising audio data (for example, a user's 102 spoken words, sighs, laughter, or background noise captured by a microphone) and contextual interaction data. The contextual interaction data further comprises at least one of text (for example, typed messages, chat inputs), touch signals (for example, screen taps, swipes, long presses), or gesture signals (for example, hand movements captured using a camera, device shakes, gaze direction from eye-tracking). For instance, if a user is speaking into their smartphone while tapping the screen and making hand gestures captured by the smartphone's camera, all these data streams constitute multimodal user input. The system 100 may also receive text or audio tokens from a remote server 108 for input processing (as shown in FIG. 1(B).

Before encoding, the one or more processors 104-2 further operate as an input normalization component. This one or more processors 104-2 ensures that various multimodal sensor inputs are normalized, including device orientation data (for example, gyroscope readings indicating if the user device 104 is held upright or tilted), accelerometer data (for example, detecting the user device 104 movement or shakes), and ambient audio context (for example, distinguishing speech from background music), are synchronized to a unified temporal reference. This alignment is crucial for accurate real-time processing and understanding of how different inputs relate to each other. For example, if a user says “I am so happy” while simultaneously making a thumbs-up gesture and the smartphone detects a slight upward tilt, normalizing these inputs ensures the system correctly interprets them as a single, positive expression.

Following reception and normalization, the processors 104-2 extract semantic and emotional context from the user input using a natural-language processing (NLP) module 104-21. The natural-language processing (NLP) module 104-21 performs an encoding process that transforms raw multimodal user inputs into a unified set of feature vectors. This unified set of feature vectors represents the acoustic and semantic content of the audio data and contextual interaction data. Critically, this set also includes affective features derived from the multimodal user inputs, which correspond to an inferred emotional state of the user 102. The NLP module 104-21 facilitates this process by performing several specialized tasks and generating embeddings that represent linguistic content, conversational intent, and affective cues. In one embodiment, the NLP module comprises a transformer-based encoder-decoder network configured to generate latent conversational embeddings encoding both semantic intent and emotional tone.

The NLP module 104-21 performs spectral analysis on audio data to extract features such as Mel-frequency cepstral coefficients (MFCCs), fundamental frequency (pitch), energy, duration, and vocal intensity. These spectral and prosodic features are vital for recognizing emotional nuances in speech. For example, a rapid pitch variation and high energy might indicate excitement, while a slower tempo and lower pitch could suggest sadness or contemplation.

For textual input, the NLP module 104-21 generates semantic embeddings. This involves using natural language processing (NLP) techniques (for example, transformer-based models) to convert words or sentences into dense numerical vectors that capture their meaning, context, and sentiment.

Positional or temporal gesture data (for example, from camera-based pose estimation or touch event sequences) is converted into structured gesture vectors. This involves tracking key points on a user's 102 hand or body over time, analyzing speed and direction of movement, or identifying specific touch patterns. A rapid, expansive hand movement, for example, would be encoded as a vector indicative of energetic expression.

A critical part within the encoding process is an affective-fusion mechanism. This mechanism is specially configured to generate a comprehensive affective-state vector by intelligently combining acoustic, semantic, and gesture-based emotion cues. The mechanism achieves this through a sophisticated weighted attention function. The weighted attention function dynamically assigns different levels of importance (weights) to each modality based on its perceived reliability or salience in a given context. For instance, if a user says “I am perfectly fine” with a forced smile and strained voice, the affective-fusion mechanism might give greater weight to acoustic and gestural cues (facial micro-expressions, body language) to accurately infer an underlying negative emotional state, overriding the literal semantic content.

To ensure temporal consistency in the companion's 106 emotional responses, the system 100 further comprises a short-term affective-state memory buffer 104-211. This buffer 104-211 stores short-term affective-state vectors from previous interactions, maintaining a history of the user's 102 emotional trajectory. This prevents “emotional flickering” where the companion's 106 response might drastically change based on a single, momentary input. For example, if a user 102 has been expressing joy for several minutes and then briefly sighs, the affective-state memory buffer 104-211 helps the system 100 interpret the sigh as a momentary lapse or a natural part of conversation, rather than instantly switching the companion 106 to a sad demeanor.

The unified set of feature vectors and embeddings, including the inferred affective features, serves as input to the core intelligence of the system 100, a motion mapping and emotional mapping module 104-22. The mapping module 104-22 is stored and executed entirely locally on the user device 104, making it a cornerstone for privacy, responsiveness, and offline functionality. The mapping module 104-22 is explicitly configured for on-device inference, meaning motion synthesis and rendering inferences required to generate the companion's 106 behavior occur directly on the user device's 104 processors 104-2. The mapping module 104-22 processes the embeddings to generate animation parameters defining expressions, gestures, and full-body motion responsive to the extracted semantic and emotional context.

In various embodiments, the mapping module 104-22 may comprise a diffusion model, a variational-autoencoder (VAE), a hybrid transformer architecture, or a multimodal transformer architecture. These architectures are trained to generate temporally coherent motion sequences conditioned on the conversational embeddings. The architecture may include modality-specific encoder layers for linguistic, acoustic, and gesture inputs, as well as a shared decoder that synthesizes motion trajectories. These animation parameters precisely define the expressions, gestures, and overall motion of the animated companion 106, encompassing detailed facial expressions, body language, and gaze motion.

The mapping module 104-22 may further include an emotional-mapping subnetwork configured to correlate sentiment or emotion scores from the NLP module with motion vectors defining posture, gaze, and gesture magnitude. Furthermore, the mapping module 104-22 includes a temporal modeling component that employs attention or recurrent layers to predict pose transitions and maintain movement continuity.

This on-device capability is enabled by strategically applying one or more model-reduction or acceleration techniques during the model training stage. These techniques make the network efficient enough to run on typical user device 104 hardware without compromising expressive quality:

Pruning: Removing redundant connections or neurons from the neural network that contribute minimally to its performance.

Quantization: Reducing the numerical precision of the model's weights and activations (for example, from 32-bit floating-point numbers to 8-bit integers), which significantly reduces model size and speeds up computation. This includes hardware-aware compilation and training-stage quantization of pre-quantized weights or activations to minimize latency and power consumption during inference.

Knowledge Distillation: This technique involves training the mapping module 104-22 (for example, the student model) to mimic the output behavior of a much larger, more complex “teacher” model. The student model learns to retain the teacher's rich emotional and expressive behaviors while operating with a significantly smaller footprint, enabling execution on the user device 104 without remote inference.

Once the animation parameters are generated, a dedicated rendering engine 104-23 takes over to visually bring the animated companion 106 to life. The rendering is performed in temporal synchronization with the user's 102 real-time input, ensuring that the companion's 106 actions appear natural and responsive. For instance, if the user 102 laughs, the companion 106 should smile and perhaps mimic a slight head tilt at the exact moment.

The rendering engine 104-23 includes a sophisticated motion-retargeting engine. The engine is responsible for mapping the abstract animation parameters generated by the mapping module onto a locally stored three-dimensional character rig (in the memory 104-3). The character rig typically consists of a skeletal structure with joints, skinning data that deforms the mesh, and blend shapes (morph targets) for facial expressions. The motion-retargeting engine translates parameters “smile intensity 0.8” or “raise left arm to 45 degrees” into specific transformations and blend shape activations on the character rig, ensuring the companion's 106 movements are anatomically plausible and expressive.

Furthermore, the rendering engine 104-23 includes a compositing engine to seamlessly display the animated companion 106 within various digital environments rendered by the user device 104. These environments may include a conversational interface (for example, a chatbot window), a gaming environment (for example, as an in-game character or NPC), or an augmented-reality (AR) environment (for example, overlaying the companion 106 onto the real world viewed through the user device's 104 camera). For example, the compositing engine may display the companion 106 as a virtual assistant hovering over your physical desk in AR, or as a companion 106 dynamically reacting to your voice commands within a mobile game.

A foundational principle of this system 100 is privacy. The animation parameters and the original user 102 inputs are explicitly not transmitted to a remote server during the execution of the mapping module 104-22. This design ensures that sensitive user interaction data remains on the user's device 104, providing a robust privacy guarantee. Furthermore, upon user consent, the system 100 transmits non-identifying usage metadata to a remote server 108.

For broad commercial deployment, the system 100 incorporates methods for efficiently integrating the animated companion 106 into various applications and platforms. This involves a model-compaction module that systematically processes a generative model using one or more reduction techniques (pruning, quantization, weight sharing, and knowledge distillation, as discussed above). The goal is to form a highly efficient on-device motion-synthesis network that can be executed within the diverse computational and memory resources typical of user devices 104. The model-compaction module is used for performing a pre-deployment optimization of the generative motion-synthesis model.

Subsequently, an integration engine embeds the generated animation parameters and the compacted network into a host platform. These host platforms are the environments where the animated companion 106 operates in real-world applications. Examples of such platforms include:

Communication applications: Enabling the companion 106 to act as an emotionally expressive avatar in video calls or messaging apps.

Virtual-assistant frameworks: Giving virtual assistants a face and a dynamic personality that reacts to the user's 102 queries and emotions.

Gaming engines: Integrating NPCs with dynamic emotional responses, enriching player immersion.

Extended-reality (XR) environments: Deploying companions 106 in virtual reality (VR), augmented reality (AR), or mixed reality (MR) for interactive experiences.

This comprehensive system 100 offers an innovative paradigm for human-computer interaction by bringing emotionally intelligent digital companions 106 directly to user devices 104. By meticulously receiving multimodal inputs, encoding complex emotional cues, and leveraging highly optimized on-device AI for behavioral generation and rendering, the system 100 delivers unparalleled privacy, responsiveness, and immersion. Imagine a user 102 wearing an AR headset (user device 104) conversing with a virtual historical guide (animated companion 106) that, in real-time, subtly adjusts its facial expressions and gestures to reflect the user's interest level, confusion, or excitement as inferred from their voice and head movements (gesture signals). All of these sophisticated reactions are computed and rendered locally on the headset, providing a truly personalized, private, and seamless interactive experience, free from the latency and privacy concerns of cloud-based processing. Specifically, the motion synthesis and rendering inferences are performed on the user device without transmitting raw sensor inputs or generated animation parameters off-device.

In one exemplary scenario, a user interacts with an AI companion, Ani, on a mobile device. When the user inputs a friendly message like “Ani, tell me about your favorite adventure!”, the system processes the positive sentiment using natural language processing and awards +2 affinity points, triggering Ani's animated character to respond with a cheerful smile and an engaging story. Conversely, if the user issues a harsh command such as “Hurry up, Ani!”, the system detects negativity, deducts 1 affinity point, and adjusts Ani's response to a brief, slightly curt reply with a disappointed expression, illustrating the dynamic adjustment of interaction quality based on user behavior.

In one case, the system 100 further enhances interaction by employing computer vision analysis of video data to build a continuously evolving contextual user profile. This profile synthesizes multiple data streams, including environmental context (for example, background objects and settings), personal context (for example, user 102 attire and accessories), real-time event context (for example, on-screen content and user 102 reactions), digital behavior context, and user 102 biometrics or parameters. This rich profile directly informs and derives the companion's 106 dialogue, enabling responses that are highly relevant to the user's 102 immediate situation and historical patterns. Furthermore, the system 100 leverages this contextual understanding to dynamically customize the companion's 106 visual appearance, including clothing and hairstyle, moving beyond rigid models to provide a truly adaptive, personalized embodied agent.

A few exemplary scenarios are discussed below to explain the operation of the system 100:

Scenario 1: Environmental Context for Proactive Assistance: A user is working on a physical model car at their desk, with their tablet device nearby. The system's computer vision analysis identifies the model car, tools, and an open instruction manual from the camera feed. This environmental context is logged in the user's profile. Noting the user's prolonged focus and the complex nature of the task, the animated companion initiates a derived dialogue: “That engine assembly looks tricky. Would you like me to display a 3D animated guide for this step?” The companion's offer is directly generated from its understanding of the visual scene and the user's potential need for assistance.

### Scenario 2: Personal Context & Dynamic Appearance: a User Is

wearing a festive sweater for a holiday party. The computer vision analysis detects the shirt's distinctive, colorful pattern and logs it as personal context. The companion, referencing this visual data, generates the dialogue, “I love your festive sweater! It is putting me in the spirit!” Simultaneously, the rendering engine dynamically changes the companion's own default outfit to a virtual holiday-themed sweater, demonstrating context-aware appearance modification that aligns with the user's real-world situation.

Scenario 3: Real-Time Event Context & Empathetic Reaction: A user is watching a live sports event on their smart TV, which is mirrored on their tablet. When their team scores a winning goal, the user leaps to their feet and cheers. The computer vision analysis detects this pronounced euphoric reaction, jumping, arms raised, and links it to the on-screen digital behavior context (the live game). The companion, leveraging this real-time data, generates an empathetic dialogue: “What an incredible goal! I can see how excited you are! That was a championship-winning play!” This demonstrates how the system uses visual reaction tracking to inform relevant and emotionally resonant conversational topics.

Scenario 4: Habit and Biometric Context for Personalized Coaching: A user begins their evening wind-down routine. The contextual profile, enriched with historical data, indicates that the user typically reads a book at this time and that past biometric data from a wearable shows a lower heart rate during this activity. Tonight, the computer vision analysis notes that the user is pacing instead. Synthesizing this deviation from the habit pattern with the real-time visual data, the companion generates a concerned dialogue: “You seem a bit restless tonight compared to usual. Would you like to listen to some calming music instead of reading?” This illustrates a personalized interaction derived from the fusion of historical habit patterns and real-time visual cues. In one example, the system executes inference using pre-quantized weights or activations produced during training-time, post-training quantization, or quantization-aware training to reduce model size and memory transfers without performing dynamic quantization of intermediate activations at runtime.

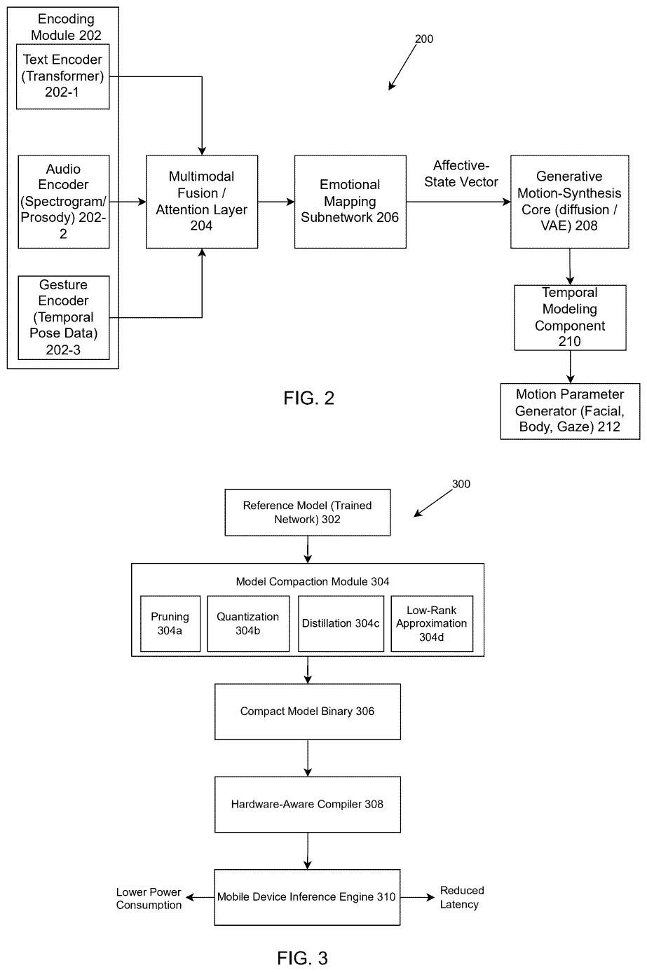

FIG. 2 illustrates a detailed architecture 200 of the motion mapping and emotional mapping module in accordance with an exemplary embodiment of the present invention. The architecture 200 depicts the flow of multimodal user inputs through various processing stages to ultimately generate animation parameters for the emotionally guided digital companion.

The process begins by processing raw multimodal user inputs through a series of modality-specific encoders or encoding module 202, which are part of the natural-language processing (NLP) and feature extraction stages. The encoders or encoding module 202 comprises a text encoder 202-1, an audio encoder 202-2, and a gesture encoder 202-3, which transforms the raw data into structured feature vectors and embeddings:

Text Encoder 202-1 (Transformer): The text encoder 202-1 receives textual input (for example, typed messages, transcribed speech). Leveraging a transformer-based encoder-decoder network, the text encoder 202-1 generates semantic embeddings that capture the linguistic content, conversational intent, and sentiment of the text. For instance, the phrase “This is fascinating” would be converted into a latent conversational embedding representing strong positive interest.

Audio Encoder 202-2 (Spectrogram/Prosody): The audio encoder 202-2 processes audio data from the user device. The audio encoder 202-2 performs spectral analysis to derive spectral and prosodic features, for example, pitch, intensity, speech rate, and vocal timbre. These features are crucial for identifying affective cues in speech, like the difference between a joyful laugh and a sarcastic chuckle.

Gesture Encoder 202-3 (Temporal Pose Data): The gesture encoder 202-3 processes gesture signals (for example, hand movements, body posture, device orientation). The gesture encoder 202-3 encodes positional or temporal gesture data into gesture vectors. For example, a rapid, expansive hand gesture could be encoded as a vector signifying enthusiasm, while a slow, drooping motion might indicate sadness.

The outputs from the three modality-specific encoders (202-1, 202-2, 202-3) comprising the semantic embeddings, spectral and prosodic features, and gesture vectors converge into a multimodal fusion/attention layer 204. This layer 204 embodies an affective-fusion mechanism and uses a weighted attention function to intelligently combine diverse cues into a unified representation. For example, if a user says “I am perfectly fine” (neutral text) but with a nervous tremor in their voice (negative audio cue) and fidgeting (negative gesture cue), the attention mechanism assigns higher weights to the non-verbal cues to accurately infer an underlying emotional state of anxiety.

The output of the multimodal fusion/attention layer 204 then feeds into an emotional mapping subnetwork 206. The emotional mapping subnetwork 206 is configured to correlate sentiment or emotion scores from the NLP module with motion vectors. The emotional mapping subnetwork 206 refines the fused multimodal features to generate an explicit affective-state vector, which represents the inferred emotional state of the user. The emotional mapping subnetwork 206 may also access the short-term affective-state memory buffer (as mentioned in FIG. 1(A)-(B)) to incorporate the short-term history of prior emotional-state vectors, ensuring temporally consistent expressive behavior from the companion. For instance, if the user has been showing signs of excitement for the past several seconds, a momentary neutral input might still be interpreted as part of sustained excitement, preventing abrupt shifts in the companion's demeanor.

The affective-state vector, along with the other unified feature vectors, then proceeds to the generative motion-synthesis core 208. The generative motion-synthesis core 208 is a primary component of the mapping module and is responsible for synthesizing the raw animation data. In various embodiments, the generative motion-synthesis core 208 may be implemented using a diffusion model, a variational autoencoder (VAE), or a hybrid transformer architecture, trained to generate temporally coherent motion sequences conditioned on the input embeddings.

Following the core synthesis, a temporal modeling component 210 processes the initial motion representations. The temporal modeling component 210 is crucial for ensuring smooth, realistic motion sequences and may employ attention mechanisms or recurrent layers to predict pose transitions and maintain movement continuity. The temporal modeling component 210 learns dependencies across animation frames to ensure that a subtle shift from surprise to joy is animated as a smooth transition, rather than an abrupt jump.

Finally, the processed motion information from the temporal modeling component 210 is passed to the motion parameter generator 212 (facial, body, gaze). The motion parameter generator 212 is the ultimate output stage of the architecture 200. The motion parameter generator 212 translates the abstract motion representations into concrete animation parameters that define specific expressions, gestures, and full-body motion for the digital companion. These parameters encompass detailed facial expressions (for example, via blend shapes for eye widening, eyebrow furrowing, or mouth shapes), body language (for example, posture adjustments or hand gestures), and gaze motion (for example, eye direction or head turns). The animation parameters are then used by the rendering engine (as discussed above) to animate the companion.

FIG. 3 illustrates a process 300 of model-compaction and deployment in accordance with an exemplary embodiment of the present invention. The process 300 is fundamental to achieving the on-device inference capabilities of the generative animation system for an emotionally-guided digital companion.

The process 300 begins with a reference model (trained network) 302. This represents a larger, typically more complex generative model, which may be a diffusion model, variational autoencoder (VAE), or hybrid transformer architecture trained on extensive datasets. This larger reference model serves as the “teacher” in a knowledge distillation process, containing the full expressive capabilities and emotional nuances that the compact model aims to emulate.

From the reference model 302, the process moves to a model compaction module 304. The model compaction module 304 is responsible for applying one or more sophisticated reduction techniques to significantly shrink the model's size and computational demands without a substantial loss in performance or expressive quality, forming an optimized on-device motion-synthesis network. The model compaction module 304 comprises several key techniques (during training stage), including a pruning 304a, a quantization 304b, a distillation 304c, and a low-Rank approximation & weight sharing 304d. The sub-boxes within the model compaction module 304 represent these key techniques:

Pruning 304a: The pruning 304a involves identifying and removing redundant weights or connections within the neural network. By eliminating less critical parts of the model, the overall size and computational complexity are reduced.

Quantization 304b: The quantization 304b reduces the numerical precision of the model's weight and activations. Instead of using high-precision floating-point numbers (for example, 32-bit), values are converted to lower-precision formats (for example, 8-bit integers), using pre-quantized weights or activations produced during training-time, post-training quantization, or quantization-aware training. This dramatically reduces the model's memory footprint and accelerates calculations without dynamically quantizing intermediate activations at runtime.

Distillation 304c: The distillation 304c (“knowledge distillation”) involves training a smaller “student” network to mimic the output behavior of the larger reference model 302 (the “teacher” model). This allows the compact model to retain the sophisticated emotional and expressive behaviors of the larger model while being significantly more efficient.

Low-Rank Approximation & Weight Sharing 304d: This technique approximates high-dimensional weight matrices with lower-rank matrices and shares weights across parts of the network, further reducing the number of parameters and computational cost.

The output of the model compaction module 304 is a compact model binary 306. This is the compact generative model 306 itself, a highly optimized, small-footprint version of the original network, specifically designed and compacted for on-device inference within the computational limits of a user device.

The compact model binary 306 then proceeds to a hardware-aware compiler 308. The hardware-aware compiler 308 performs hardware-aware compilation, translating the compact model into machine code optimized for the specific hardware architecture (for example, CPU, GPU, Neural Processing Unit (NPU)) of the user device. This step is crucial for minimizing latency and power consumption during inference.

Finally, the optimized code is deployed to a mobile device inference engine 310. The mobile device inference engine 310 represents the runtime environment on the user device where the compact generative network is executed locally as part of the motion mapping and emotional mapping module. All processing of user inputs to generate animation parameters occurs within this engine, completely on-device.

The entire optimization and deployment pipeline is depicted in FIG. 3 directly enables efficient on-device inference. By executing the compact network locally without transmitting raw sensor inputs or generated animation parameters to a remote server, the system eliminates network delays, enabling immediate, fluid interactions with low latency. Furthermore, the extensive model compaction and hardware-aware compilation during the model training stage result in fewer computations and more efficient memory usage, significantly reducing power consumption and extending battery life. This on-device, optimized execution ensures that the animated companion reacts swiftly and sustainably to multimodal user inputs.

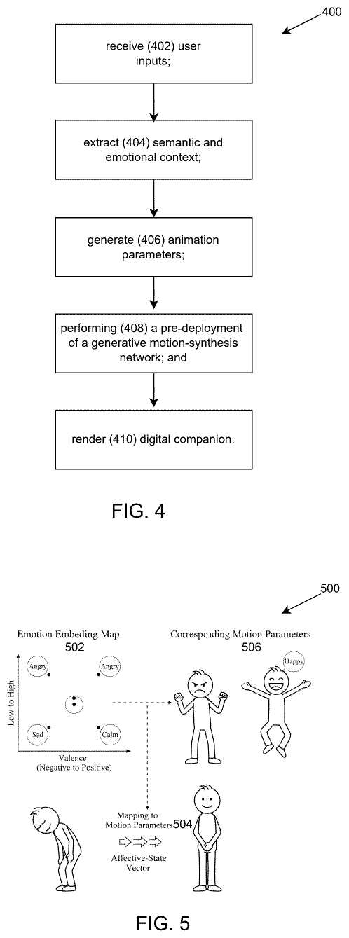

FIG. 4 is a flowchart depicting a method 400 for generating an emotionally-guided digital companion on a user device in accordance with an embodiment of the present invention.

The method 400 begins with the step of receiving 402, a user input. In this step of receiving 402, the system acquires diverse user inputs, including at least one of text, voice, touch, or gesture data. These multimodal inputs also include device orientation, accelerometer data, and ambient audio, which are normalized to a unified temporal reference to ensure synchronized processing. In one scenario, this step may also include receiving text or audio tokens from a remote server.

Next, the method 400 proceeds to extract 404, the semantic and emotional context from the user input. This step 404 involves a natural-language processing module, which may comprise a transformer-based encoder-decoder network. This module generates embeddings that capture the linguistic content, conversational intent, and affective cues in the user input.

The method 400 then involves generating 406, animation parameters responsive to the extracted context. This critical step is performed by a motion mapping and emotional mapping module executed locally on the user device. This module, which may use a diffusion, VAE, or hybrid transformer architecture, processes embeddings to generate animation parameters for facial expressions, gestures, and full-body motion. The module includes a temporal modeling component that may employ attention or recurrent layers to maintain continuity of movement and ensure that motion sequences are temporally coherent. An emotional-mapping subnetwork within this module correlates sentiment or emotion scores from the NLP module with specific motion vectors.

Concurrently, the method 400 involves performing a pre-deployment optimization 408 of a generative motion-synthesis network for on-device inference. A short-term affective-state memory buffer stores the recent emotional-state vector. This ensures that the generative process produces temporally consistent expressive behavior by considering the recent emotional history, not just the immediate input.

The method 400 continues with rendering 410, a three-dimensional animated companion in temporal synchronization with the received input. This step is performed by a rendering engine that uses the generated animation parameters. The rendering engine includes a motion-retargeting module configured to map the animation parameters onto a locally stored skeletal rig or mesh of a character. The engine then composites the animated companion within a communication, gaming, or augmented-reality interface. Crucially, this rendering is synchronized with the received user inputs, ensuring a natural, fluid interaction.

Throughout this entire method, 400, motion-synthesis and rendering inferences are performed on the user device. During inference operations, raw sensor input or generated animation parameters are stored locally on the device and not transmitted off-device. Furthermore, upon user consent, the method 400 includes transmitting non-identifying usage metadata.

FIG. 5 illustrates a visual example of an affective mapping process 500 performed by an emotional-mapping subnetwork, correlating emotion embeddings to motion-control parameters in accordance with an embodiment of the present invention.

The left panel of FIG. 5 depicts a two-dimensional emotion embedding map 502. This map 502 visualizes a continuous emotional space derived from the natural-language processing module, with a valence axis and an Arousal axis. Specific emotional states are represented as points, for example, happiness, sadness, anger, and calm. These points represent the affective cues and sentiment scores encoded in the embeddings.

Dashed arrows illustrate the mapping process 504 performed by the emotional-mapping subnetwork within the broader motion-mapping and emotional-mapping module. The mapping process 504, shown by arrows, conceptually connects the emotion embedding map 502 to corresponding motion parameters 506 to generate specific animation parameters.

The right panel showcases the corresponding motion parameters 506 as a series of stick-figure icons, visually representing how the subnetwork correlates emotional state with motion vectors defining posture, gaze, and gesture magnitude. For instance, a “Happy” embedding maps to parameters for an open posture and upward gaze, while a “Sad” embedding maps to a slouched posture and lowered gaze. An “Angry” state might elicit parameters for raised arms, a furrowed brow, and an intense gaze. The generative core produces the behavioral parameters defining facial, body, and gaze motion.

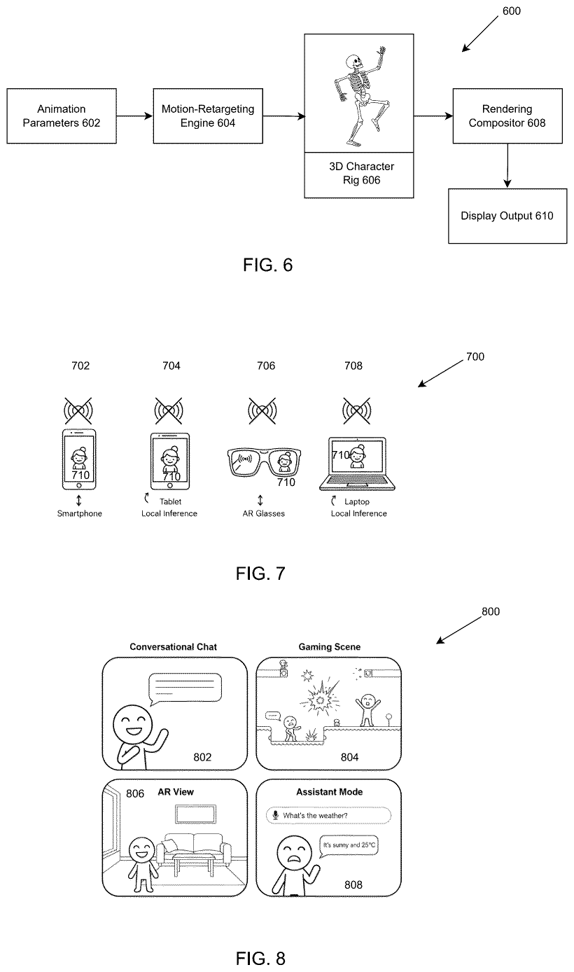

FIG. 6 shows a rendering pipeline 600 of a rendering engine that applies generated animation parameters to a 3D character rig and composites the animated companion for real-time display in accordance with an embodiment of the present invention.

The pipeline 600 begins with animation parameters 602. These parameters 602, defining expressions, gestures, and full-body motion, are generated by the locally executed motion mapping and emotional mapping module.

These animation parameters 602 are fed into a motion-retargeting engine 604. The motion-retargeting engine 604, a component of the rendering engine, is responsible for translating the generic animation parameters into concrete movements for a specific character model.

The motion-retargeting engine 604 applies these parameters to a three-dimensional (3D) character rig 606. The three-dimensional character rig 606 is a locally stored skeletal structure or mesh of the user-customized digital companion. The simplified 3D avatar rig 606 is visually animated at this stage, showing its skeleton lines or mesh moving according to the input parameters.

The animated 3D character rig 606 is processed by a rendering compositor 608. The rendering compositor 608 combines the animated character with a host platform environment, such as a conversational interface, gaming engine, or augmented-reality scene.

The final output is directed at displaying output 610, presenting the emotionally guided digital companion to the user in real time. This entire rendering process occurs on the user device and is temporally synchronized with the user's inputs, ensuring a seamless, responsive user experience.

FIG. 7 illustrates exemplary hardware environments 700 for on-device deployment of the compact generative animation system in accordance with an embodiment of the present invention. The figure displays four distinct user device icons, each showcasing the emotionally guided digital companion on its screen, indicative of local rendering. These devices include a smartphone 702, a tablet 704, augmented reality (AR) glasses 706, and a laptop 708. On the screen of each device, a miniature avatar renders 710 is depicted, representing the digital companion is depicted for the user.

Crucially, arrows indicating “local inference” are associated with each device, highlighting that the entire process from processing user inputs via the natural-language processing and motion-mapping modules to rendering via the rendering engine is executed directly on the user device. This local execution ensures real-time responsiveness and user privacy, as all motion-synthesis and rendering inferences occur locally without transmitting raw sensor inputs or generated animation parameters off-device. The inclusion of crossed-out wireless network icons further emphasizes this “no cloud processing” paradigm, reinforcing the system's ability to operate autonomously on the local device.

FIG. 8 illustrates user-interface mock-ups 800 demonstrating real-time animated companion behavior within specific host platforms in accordance with an embodiment of the present invention. The FIG. 800 is arranged in a grid of four small screens, each representing a different integration environment for the rendering engine.

The first screen 802, labeled “Conversational Chat”, depicts the animated companion within a communication interface. Here, the companion's facial expressions and gestures, generated by the motion mapping and emotional mapping module, are rendered in temporal synchronization with user voice or text inputs, providing an engaging and responsive conversational experience.

The second screen, 804, labeled “Gaming Scene”, showcases the companion character integrated into a gaming engine. In this context, the companion reacts to in-game events, demonstrating the system's ability to generate context-aware, full-body motion that enhances the interactive gaming environment.

The third screen, 806, labeled “Augmented Reality (AR) View”, illustrates an augmented-reality application where the rendering engine composites the animated companion onto a live camera feed. This exemplifies the seamless integration of the emotionally guided digital companion into a user's real-world environment.

The fourth screen, 808, labeled “Assistant Mode”, displays the animated companion acting within a virtual-assistant framework. This scenario emphasizes the companion's ability to interpret user queries and deliver emotionally appropriate, visually expressive responses, highlighting the real-time, on-device generation of animation parameters.

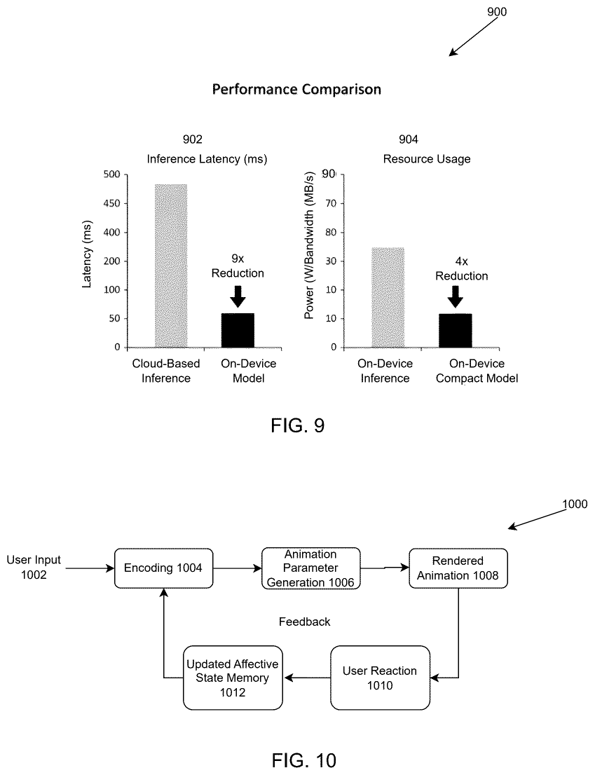

FIG. 9 illustrates an analytical comparison 900 highlighting the performance advantages of the disclosed on-device generative animation system against conventional cloud-based inference in accordance with an embodiment of the present invention. The analytical comparison 900 in the figure underscores the system's efficiency and responsiveness enabled by its local processing capabilities.

The figure prominently displays two bar graphs providing a clear contrast of crucial performance metrics. The Y-axis of the first graph 902 is dedicated to measuring latency (ms), which represents the critical time delay involved in generating the animation. A lower latency value indicates a more immediate and fluid user experience, which is essential for maintaining temporal synchronization with user inputs. Complementing this, the Y-axis of secondary graph 904 measures power consumption, indicating the computational resources used by each approach.

The comparison 900 is distinctly drawn between “cloud-based inference” and the “on-device compact model”. Cloud-based inference requires transmitting user input to a remote server for processing, introducing inherent network delays and consuming significant bandwidth. In contrast, the “on-device compact model” represents the system's execution of the motion mapping and emotional mapping module directly on the local user device, optimized via techniques such as pruning, training-stage quantization and knowledge distillation (employed during the training stage).

The graphs (902, 904) are configured to visually highlight large improvement bars specifically for the “on-device compact model” 910. These pronounced improvements graphically demonstrate a significant reduction in latency, which is critical for real-time interactivity. Furthermore, the on-device model exhibits substantially lower power consumption, a direct result of hardware-aware compilation and optimization, which extends battery life on portable devices.

In essence, the on-device system provides immediate, real-time responses that are synchronized with user interactions, operating with remarkable efficiency directly on user devices. This not only ensures a fluid, seamless user experience but also inherently protects user privacy by keeping all sensitive data and inference operations localized.

FIG. 10 illustrates a feedback loop 1000 for maintaining affective continuity by updating a short-term affective-state memory based on ongoing user interactions, in accordance with an embodiment of the present invention. This figure illustrates the dynamic interaction between the user and the animated companion, ensuring the companion's emotional responses evolve naturally over time in response to ongoing user interactions.

The process begins with a user input 1002, which comprises at least one of text, voice, touch, or gesture data. This input is then directed to an encoding stage 1004, performed by the natural-language processing module. Here, the semantic and emotional context is extracted to generate embeddings representing linguistic content, conversational intent, and affective cues.

Following the encoding stage 1004, these embeddings are processed by the motion mapping and emotional mapping module in an animation parameter generation stage 1006. This module, which includes a temporal modeling component, generates animation parameters that define the companion's expressions, gestures, and full-body motion. The output is a rendered animation 1008, displayed to the user in temporal synchronization with their input.

A user's subsequent reaction 1010 is captured as a new input. This new data is used to update a short-term affective-state memory 1012. This memory buffer stores recent emotional-state vectors, allowing the system to maintain temporal coherence in the companion's expressive behavior.

Crucially, the information from the updated affective-state memory 1012 is fed back into the encoding and generation stages (1004, 1006). This connection closes the loop, ensuring that the companion's emotional responses are not based solely on immediate input but are conditioned by recent emotional history. This feedback mechanism is key to producing a temporally consistent and emotionally intelligent digital companion.

The figures illustrate the architecture, functionality, and operation of possible implementations of the system and method according to various embodiments of the present invention. It should also be noted that, in some alternative implementations, the functions noted/illustrated may occur out of the order noted. For example, two blocks shown in succession may, in fact, be executed substantially concurrently, or the blocks may sometimes be executed in the reverse order, depending upon the functionality involved.

Since various possible embodiments might be made of the above invention, and since multiple changes might be made in the embodiments above set forth, it is to be understood that all matter herein described or shown in the accompanying drawings is to be interpreted as illustrative and not to be considered in a limiting sense.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprise” and/or “comprising”, when used in this specification, specify the presence of stated features, integers, steps, operations, elements, and/or components, but do not preclude the presence or addition of one or more other features, integers, steps, operations, elements, components, and/or groups thereof.

The present invention and some of its advantages have been described in detail for some embodiments. It should be understood that although the system and method are described with reference to an emotionally reactive animation generation system and method, they may be used in other contexts as well. It should also be understood that various changes, substitutions, and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, and composition of matter, means, methods, and steps described in the specification. A person having ordinary skill in art will readily appreciate from the disclosure of the present invention that processes, machines, manufacture, compositions of matter, means, methods, or steps, presently existing or later to be developed, are equivalent to, and fall within the scope of, what is claimed. Accordingly, the appended claims are intended to include within their scope such processes, machines, manufacture, compositions of matter, means, methods, or steps.

1. A generative animation system, comprising:
one or more processors and a memory storing executable instructions that, when executed by the one or more processors, cause the system to:
receive at least one user input comprising at least one of text, voice, touch, or gesture data;
extract semantic and emotional context from the user input using a natural-language processing module configured to generate embeddings representing at least one of linguistic content, conversational intent, or affective cues;
process the embeddings, via a motion mapping and emotional mapping module to generate animation parameters defining at least one of facial expressions, gestures, and full-body motion responsive to the extracted semantic and emotional context; and
render, using a rendering engine, an emotionally-guided digital companion in temporal synchronization with the received user input based on the animation parameters, wherein motion-synthesis and rendering inferences are performed on the user device without transmitting raw sensor inputs or generated animation parameters off-device.

2. The system of claim 1, wherein the natural-language processing module comprises a transformer-based encoder-decoder network configured to generate latent conversational embeddings encoding both semantic intent and emotional tone.

3. The system of claim 1, wherein the mapping module comprises a diffusion, variational-autoencoder, or hybrid transformer architecture trained to generate temporally coherent motion sequences conditioned on the conversational embeddings.

4. The system of claim 1, wherein the mapping module comprises an emotional-mapping subnetwork configured to correlate sentiment or emotion scores from the natural-language processing module with motion vectors defining posture, gaze, and gesture magnitude.

5. The system of claim 1, wherein the one or more processors normalize multimodal sensor inputs, including device orientation, accelerometer data, and ambient audio, to a unified temporal reference prior to encoding.

6. The system of claim 1, further comprising a short-term affective-state memory configured to store recent emotional-state vectors for use in producing temporally consistent expressive behavior.

7. The system of claim 1, wherein the mapping module further includes a temporal modeling component employing attention or recurrent layers to predict pose transitions and maintain continuity of movement.

8. The system of claim 1, wherein the on-device optimization includes hardware-aware compilation or training-stage quantization of pre-quantized weights or activations to minimize latency and power consumption during inference.

9. The system of claim 1, wherein the rendering engine includes a motion-retargeting module configured to map generated animation parameters to a locally stored skeletal rig or mesh of a user-customized character.

10. The system of claim 1, wherein the rendering engine composites the animated companion within a conversational, gaming, or augmented-reality interface rendered by the user device.

11. The system of claim 1, wherein the system receives text or audio tokens from a remote server and, upon user consent, transmits non-identifying usage metadata.

12. A computer-implemented method for generating a real-time, interactive companion on a user device, comprising:
receiving a user input comprising at least one of text, voice, touch, or gesture data;
extracting semantic and emotional context from the user input using a natural-language processing module that generates embeddings representing linguistic content, conversational intent, or affective cues;
generating, by a mapping module executed locally on the user device, animation parameters defining expressions, gestures, and full-body motion responsive to the extracted context;
performing a pre-deployment optimization of a generative motion-synthesis network for on-device inference using one or more model-reduction or acceleration techniques selected from pruning, quantization, weight sharing, low-rank approximation, or knowledge distillation; and
rendering, by the user device, a three-dimensional animated companion in temporal synchronization with the received inputs based on the generated animation parameters, wherein motion-synthesis and rendering inferences are performed on the user device without transmitting raw sensor inputs or generated animation parameters off-device.

13. The method of claim 12, wherein extracting semantic and emotional context comprises generating transformer-based embeddings encoding sentiment, intent, and conversational state.

14. The method of claim 12, wherein generating the animation parameters comprises predicting sequential joint rotations, facial blendshapes, and body poses using a diffusion or variational-autoencoder-based network conditioned on the embeddings.

15. The method of claim 12, further comprising mapping emotion embeddings to animation-control parameters through an emotional-mapping subnetwork that aligns expressive behavior with conversational tone.

16. The method of claim 12, further comprising maintaining an affective-state memory buffer storing recent emotional-state vectors for use by the generative motion-synthesis network to ensure temporal coherence of emotional responses.

17. The method of claim 12, wherein the mapping module includes modality-specific encoder layers for linguistic, acoustic, and gesture inputs and a shared decoder configured to synthesize motion trajectories.

18. The method of claim 12, further comprising generating the motion and, or emotion mapping by distilling parameters from a larger reference model to create a compact model executable within computational limits of the user device.

19. The method of claim 12, further comprising executing inference using pre-quantized weights or activations produced during training-time, post-training quantization, or quantization-aware training to reduce model size and memory transfers without performing dynamic quantization of intermediate activations at runtime.

20. The method of claim 12, wherein rendering comprises retargeting the generated animation parameters onto a three-dimensional character rig stored locally and compositing the resulting animation within a communication, gaming, or extended-reality interface.

21. The method of claim 12, wherein receiving text or audio tokens from a remote server and, upon user consent, transmitting non-identifying usage metadata.

22. A computer-implemented method for compacting and deploying an interactive companion, comprising:
receiving training data comprising audio, textual, and motion data annotated with emotional context;
compacting a generative model using at least one reduction technique selected from pruning, quantization, weight sharing, or knowledge distillation to form an optimized on-device motion-synthesis network;
executing the compact network locally on a user device to transform user inputs into animation parameters defining expressive motion and gesture of a three-dimensional character; and
integrating the compact network and generated animation parameters into a host platform comprising at least one of a conversational interface, virtual-assistant framework, gaming engine, or augmented-reality environment.
